(19) United States
(12) Patent Application Publication
(10) Pub. No.: US 2004/0015709 A1
(43) Pub. Date: Jan. 22, 2004

(54) Software delivery device and method for providing software copy protection

(76) Inventors: Bei-Chuan Chen, Taipei City (TW); Po-Kun Tseng, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,483

(22) Filed: Jul. 18, 2002

(51) Int. Cl. G06F 12/14

(52) U.S. Cl. 713/193

(57) ABSTRACT

A software delivery device includes a connection port for connecting to a computer, a microcontroller, a flash memory comprising a file system and a boot sector, and a software program stored in the flash memory. The microcontroller controls communication between the connection port and the flash memory and blocks communication between the computer and the flash memory when the computer is not booted from the boot sector. An authentication program stored in the microcontroller is executed when the computer is booted to prevent unauthorized duplication and execution of the software.

### BACKGROUND OF INVENTION

1. Field of the Invention

The present invention relates to a software delivery device and related method, and more specifically, to a software delivery device and related method that provides copy protection to software delivered.

2. Description of the Prior Art

Providing adequate copy protection to software is an ongoing problem in the computer software industry. In the past, pirated software had limited means of distribution. However, with the advent of the Internet, it has become easy for unscrupulous individuals to find, install, and use illegal copies of almost any commercially available program. This problem results in a complicated financial situation that eventually ends in lost revenue for the publishers of the program being recouped by the cost of the program being increased. Additionally, quality of programs produced is influenced as the publishers and vendors of the program can never be certain who is actually using a copy of the program, and thus cannot accurately study their end user market. Besides everyday software such as word processors and graphics applications, inadequate copy protection allows complex scientific, engineering, and encryption programs to be used by unauthorized parties. Moreover, users of unauthorized software include users from all sectors—personal, commercial, and industrial.

Currently, there is a wide array of prior art methods of providing software copy protection. One popular method involves including a code generating and prompting routine in the program to be protected. When a user executes the program, the user is prompted to enter a unique key code that is then validated against a code generated by the program. While this method is quite simple, it can easily be defeated. For instance, the code generation routine of the program can be reverse engineered, and a small key generation utility can be written to generate a key for a given copy of the program. Furthermore, the prompting routine of the program can be disabled by a person of sufficient skill having access to a suitable decompiler.

Another common prior art method involves providing a program on a CD that references codes stored on the CD. These codes are not included in the installed copy of the program and must be read from the CD at the time of execution. This method can also be easily sidestepped by simply copying the CD. Moreover, this method causes inconvenience and annoyance to legitimate users of the program if the CD becomes scratched or otherwise damaged.

A third common prior art method provides a special hardware device as a means copy protection. Known as a hardware lock or dongle, this device is connected to a port of a computer and is referenced by a program during execution. The hardware lock or dongle is popularly used in conjunction with commercial and industrial applications or distributions. As shown in FIG. 1, the hardware lock 10 comprises a connection port 12. The connection port 12, typically a standard D-Type 25 Pin parallel port, can be connected to a corresponding connection port of a computer.

Please refer to FIG. 2, which shows the hardware lock 10 connected to a computer 20 through a connection port 22. The hardware lock 10 further comprises a reference table 14 that is essentially an IC chip look-up table. When the reference table 14 is sent a first value, it returns a second value. The computer 20 also includes a processor 24 for executing a program 26. The program 26 includes references to the reference table 14 of the hardware lock 10 and can terminate its own execution if any first value sent to the reference table 14 returns an invalid second value.

When the program 26 is executed, program instructions control the processor 24 to send first values to the reference table 14 and compare returned second values with expected second values. The program 26 also controls the processor 24 to halt execution of the program 26 if any of the returned second values do not agree with expected second values. Hence, if the program 26 is to be executed the hardware lock 10 must be connected to the connection port 22 of the computer 20.

Nevertheless, the hardware lock 10 has significant shortcomings. First, the program 26 is distributed on a CD or floppy disk and stored in the computer 20, on a hard drive for example, and can therefore be readily copied, decompiled, and modified to not reference the hardware lock 10, thus effectively removing the copy protection provided. Second, the IC chip reference table 14 does not actually deliver the program 26 and is consequently too expensive to justify its narrow purpose. Third, the connection port 22 to which the hardware lock 10 is attached may become unusable by other devices.

Therefore, the prior art methods and devices for providing software copy protection are too easily disabled, inconvenient, and too expensive.

### SUMMARY OF INVENTION

It is therefore a primary objective of the claimed invention to provide a software delivery device for providing software copy protection to solve the above-described problems in the prior art.

Briefly summarized the claimed invention includes a connection port for connecting to a computer, a microcontroller, a flash memory comprising a boot sector, and a program stored in the flash memory. The microcontroller contains an authentication program for booting the computer from the boot sector and is capable of controlling communication between the connection port and the flash memory.

According to the claimed invention, the microcontroller blocks communication between the computer and the flash memory when the computer is not booted from the boot sector.

According to the claimed invention, the authentication program includes instructions that instruct the microcontroller to allow access to the flash memory by the computer, and the authentication program is stored in the ROM of the microcontroller to be executed when the computer is booted from the software delivery device.

It is an advantage of the claimed invention that the program provided in the flash memory cannot be accessed by the computer if the computer is not booted from the boot sector.

It is a further advantage of the claimed invention that the flash memory and microcontroller provide both a way to deliver the program to an end user and a way to prevent unauthorized copies of the program from being generated.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective view of a prior art hardware lock.

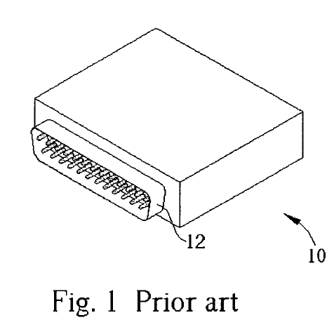

FIG. 2 is a block diagram of the hardware lock of FIG. 1 connected to a computer.

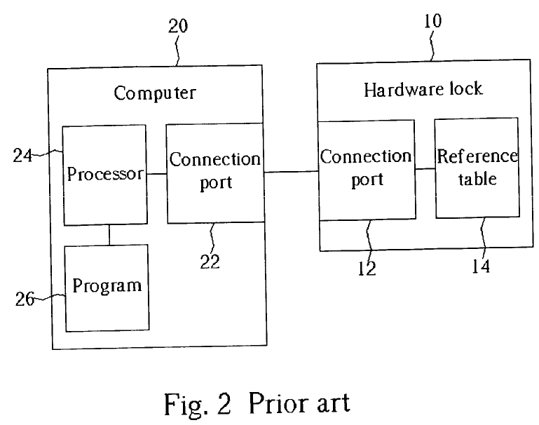

FIG. 3 is a perspective view of a software delivery device according to the preferred embodiment of the present invention.

FIG. 4 is a block diagram of the software delivery device shown in FIG. 3 connected to a computer.

### DETAILED DESCRIPTION

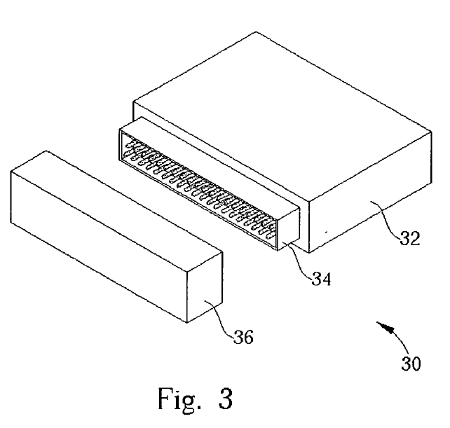

Please refer to FIG. 3, which shows a software delivery device 30 according to the preferred embodiment of the present invention. The software delivery device 30 comprises a body 32, a connection port 34, and a removable protective cover 36. The body 32 contains components that provide functionality to the software delivery device 30. The connection port 34 is a standard 40-pin male integrated drive electronics (IDE) port that is common in the computer industry, but could also be another type of computer interface port, such as small computer system interface (SCSI) or universal serial bus (USB) port, as long as the software delivery device 30 is bootable. The protective cover 36 can be removed to allow the connection port 34 to be connected a computer through a typical IDE ribbon cable.

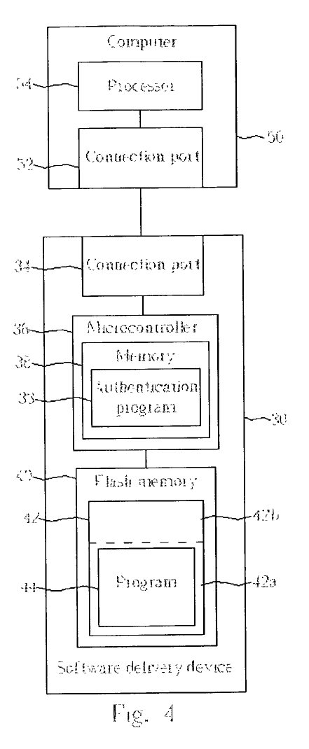

FIG. 4 is a block diagram of the software delivery device 30 connected to a computer 50. The connection port 34 is connected to a corresponding connection port 52 on the computer 50. The computer 50 comprises a processor 54 for executing programs. Naturally, the computer 50 further comprises additional hardware, such as hardware to accept user input and display output, however this is well known in the art and will not be described in further detail. The software delivery device 30 further comprises a microcontroller 36 having an internal logic and a read only memory (ROM) 38, and a flash memory 40. The microcontroller 36 controls the flow of data between the flash memory 40 and the connection port 34. Stored in the flash memory 40 is a software program 44 to be delivered to and used by an end user on the computer 50.

The microcontroller 36, with an authentication program 33 stored in the ROM 38 thereof, can accept, reject, and execute instructions from the connection port 34, which in practical application is the same as accepting, rejecting, and executing instructions from the processor 54. The microcontroller 36 can limit the scope of the instructions, and accept or reject instructions based on logic to control the flow of data between the flash memory 40 and the connection port 34. Rather than allowing direct access to the flash memory 40, the microcontroller 36 is programmed to reject read commands from the processor 54 addressed to a particular region of the flash memory 40. This ensures that a functional copy of the program 44 cannot be copied from the flash memory 40. This also ensures that the program 44 cannot be entirely executed by the processor 54 alone. The logic of the microcontroller 36 can also be controlled by instructions from the processor 54 to allow or further disallow reading and writing to different regions of the flash memory 40.

The flash memory 40 is organized into a file system 42, much the same way a typical hard disk is. For example, if the computer 50 is using a Microsoft Windows operating system the FAT32 or NTFS file system is used. Of course, the file system 42 would comply with other standards if the computer 50 were using other operating systems. The file system 42 of the flash memory 40 includes a main storage area 42a and a boot sector 42b. For explanatory purposes, the program 44 is considered as a single application. The present invention does not preclude the program 44 from being a plurality of programs as long as they are private programs to be protected from any unauthorized copying according to the present invention.

The program 44 can also include additional references to the microcontroller 36 that are stored in the main storage area 42a of the flash memory 40. These references can take the form of specialized commands, encrypted information, or similar references and instruct the processor 54 to halt execution of the program 44 if the microcontroller 36 is no longer attached to the computer 54. The purpose of these additional references is to ensure that the microcontroller 36 is not removed from the computer 50 during execution of the program 44.

Normally, the microcontroller 36 prevents access to the main storage area 42a of the flash memory 40. For instance, if the software delivery device 30 is connected to the computer 50 after the computer 50 has booted, the main storage area 42a of the flash memory 40 is inaccessible and read or write errors may occur. The boot sector 42b is normally accessible, but inherently protected from direct user access though the computer 50 by the authentication program 33.

The operation of the present invention according to the preferred embodiment is summarized as follows. First, the software delivery device 30 is connected to the computer 50. Second, the computer 50 is turned on. During startup, the BIOS of the computer searches for bootable devices and tries to read sector 0 of the flash memory 40 of the bootable device 30. Instead of returning boot sector 0 of the flash memory to BIOS, the authentication program 33 returns a virtual boot sector to the computer. The software delivery device 30 appears to the computer 50 as a bootable device having a boot sector. The authentication program 33 of the microcontroller 36 is such that it enables the computer 50 to boot from the virtual boot sector, but prevents it from gaining access to the protected program 44 in the flash memory 40. Third, when the user chooses to boot the computer 50 from the device 30, the authentication program 33 grants access to boot sectors of the flash memory 40 and normal boot sequences begin. Finally, the authentication program 33 instructs the microcontroller 36 to allow access to the protected program 44 and the main storage area 42a of the flash memory 40—in effect unlocking the flash memory 40.

An end user simply has to connect the connection port 34 to the computer 50 and boot the computer 50 as usual. In fact, from the user's perspective, the present invention software delivery device 30 is used in much the same way as a CD, floppy disk, or hard disk. However, the inventive software delivery device 30 prevents access to the program 44 unless the computer 50 is booted from the software delivery device 30.

Generally, the design of the program 44 and nature of the included instructions to the microcontroller 36, the logic of the microcontroller 36 are both factors that determine the strength of the copy protection provided by the present invention software delivery device 30. At the time of manufacture, the exact application of the present invention software delivery device 30 must be addressed to fine-tune the above factors to maximize the copy protection afforded.

In contrast to the prior art, the present invention includes an authentication program stored in a microcontroller that is executed by the computer during startup. Instructions in the program control the microcontroller to allow access to the flash memory to effectively unlock the entire software program stored therein. The present invention provides superior copy protection security to software over the prior art. The present invention further allows software to be delivered and protected by a single device in a way that is convenient to an end user.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A bootable software delivery device comprising:
a connection port for connecting the software delivery device to a computer;
a microcontroller coupling the connection port for controlling the software delivery device; and
a flash memory coupling the microcontroller for storing a software;
wherein the microcontroller is so programmed that the software is executable by the computer only when the computer is booted up from the software delivery device.

2. The software delivery device of claim 1 wherein the microcontroller prevents copying of the software from the flash memory of the software delivery device.

3. The software delivery device of claim 1 wherein the connection port is an integrated drive electronics (IDE) port.

4. The software delivery device of claim 1 wherein the connection port is a small computer system interface (SCSI) port.

5. The software delivery device of claim 1 wherein the connection port is a universal serial bus (USB) port.

6. A software delivery device for providing software copy protection, the software delivery device comprising:
a connection port for electrically connecting the software delivery device to a computer;
a microcontroller electrically connected to the connection port, in which an authentication program is installed for booting the computer from the software delivery device;
a flash memory electrically connected to the microcontroller, the flash memory comprising a boot sector for booting the computer in accordance with the authentication program; and
a private program stored in the flash memory, the private program being executable by the computer only after booting from the boot sector is performed;
wherein the authentication program instructs the microcontroller to return a virtual boot sector rather than the boot sector to the computer.

7. The software delivery device of claim 6 wherein the microcontroller prevents copying of the private program from the flash memory of the software delivery device.

8. The software delivery device of claim 6 wherein the connection port is an integrated drive electronics (IDE) port.

9. The software delivery device of claim 6 wherein the connection port is a small computer system interface (SCSI) port.

10. The software delivery device of claim 6 wherein the connection port is a universal serial bus (USB) port.

11. The software delivery device of claim 6 wherein the authentication program is stored in a read only memory of the microcontroller.

12. A method for protecting a software, the method comprising:
providing a bootable device for delivering the software, the bootable device comprising a flash memory for storing the software, a connection port for connecting to a computer, and a microcontroller for executing the software with the computer via the connection port; and
programming the microcontroller in such a way that the software is executable by the computer only when the computer is booted up from the bootable device.
